(19) United States
(12) Patent Application Publication
(10) Pub. No.: US 2012/0325752 A1
(43) Pub. Date: Dec. 27, 2012

(54) ADDITIVE DISPENSING FILTER AND METHOD

(75) Inventor: Donald William Baldwin, JR., Perrysburg, OH (US)

(73) Assignee: FRAM GROUP IP, LLC, Lake Forest, IL (US)

(21) Appl. No.: 13/431,178

(22) Filed: Mar. 27, 2012

Related U.S. Application Data
(60) Provisional application No. 61/500,317, filed on Jun. 23, 2011.

(51) Int. Cl. B01D 35/30; B01D 35/02; B05C 17/01

(52) U.S. Cl. 210/742; 222/54; 222/387; 210/149

(57) ABSTRACT

An additive cartridge for dispersing an additive within a filter housing is provided. The additive cartridge includes an additive cartridge housing having a peripheral wall, the additive cartridge housing defining first interior area and a second interior area being divided by a first wall. A first unidirectional fluid path is disposed adjacent the second end, the first fluid path defining a flow path from the second interior area. A first biasing member being made from a shape-memory alloy disposed in the second interior area adjacent the first end, the shape memory alloy moving between a first position and a second position in response to a change in temperature. A first piston member is movably disposed within the second interior area and coupled to the first biasing member, the first piston member defining a dispensing chamber within the second interior area.

### CROSS REFERENCE TO RELATED APPLICATIONS

This application is a non-provisional patent application which claims the benefit of U.S. Provisional Patent Application No. 61/500,317 filed Jun. 23, 2011, the entire contents of which are incorporated herein by reference.

### BACKGROUND OF THE INVENTION

The subject matter disclosed herein relates to an additive dispersing filter and method of dispersing an additive to a fluid passing through a filter.

Many different types of fluid filters are known. Most such filters use a mechanical or ‘screening’ type of filtration, with a porous filter element disposed therein. The oil is repeatedly cycled through the filter element to remove impurities.

In the oil filtration art, it is well known that normal operation of an internal combustion engine, particularly a diesel engine, results in the formation of contaminants. These contaminants include, among others, soot, which is formed from incomplete combustion of the fossil fuel, and acids that result from combustion. These contaminants are typically introduced into the lubricating oil during engine operation, and tend to increase oil viscosity and generate unwanted engine deposits, leading to increased engine wear.

The conventional solution to these problems has been to place various additives into lubricating oils, during their initial formulation. To combat soot-related problems, many conventional lubricating oils include dispersants that resist agglomeration of soot therein. These work well for a short period, but may become depleted. Additionally, due to the solubility and chemical stability limits of these dispersants in the oil, the service lives of the lubricating oil and the oil filter are less than optimal.

To counteract the effects of acidic combustion products, many conventional motor oils include neutralizing additives known as over-based detergents. These are a source of TBN (total base number), which is a measure of the quantity of the over-based detergent in the oil. The depletion of the TBN is an important limiting factor for many internal combustion engines, particularly for heavy-duty applications with diesel engines.

To improve engine protection and to combat other problems, conventional lubricating oils often include one or more further additives, which may be corrosion inhibitors, antioxidants, friction modifiers, pour point depressants, detergents, viscosity index improvers, anti-wear agents, and/or extreme pressure additives. While the inclusion of these further additives may be beneficial, the amount and concentration of these additives, using conventional methods, are limited by the ability of lubricating oils to suspend these additives, as well as by the chemical stability of these additives in the oil.

While the known filters are usable for their intended purposes, the release of supplemental additives from the known filters often takes place either immediately after installation or more rapidly than is needed for protecting the oil. Subsequently, after some time has elapsed, there may be little or no additive left in the filter.

Another problem with many of the known filter designs is that beneficial additives are added to the oil before the oil is mechanically filtered through a filter element. As a result, when the oil is mechanically filtered, some of the beneficial additives that have just been added may be immediately filtered out.

Moreover, recent emission regulations require heavy/medium duty diesel engines to run at conditions that deteriorate the crank case lube oil additive package at an accelerated rate. This leads to a reduction in the number of miles a truck can travel before the crank case oil needs to be changed, causing increase in downtime and operating costs of the truck, and thus reducing profits for the owner.

Therefore it is desirable to provide a filter having an additive incorporated therein, wherein the additive is slowly released over the useful life of the filter. It is also desirable to provide an oil filter which could extend the useful life of engine oil so as to allow a user to extend the time interval between oil changes of an engine.

### BRIEF DESCRIPTION OF THE INVENTION

According to one aspect of the invention, an additive cartridge for dispersing an additive within a filter housing is provided. The additive cartridge includes an additive cartridge housing having a peripheral wall, the additive cartridge housing defining first interior area and a second interior area being divided by a first wall, the first interior area defining a receiving area for receipt of the additive therein, the second interior area having a first end and a second end. A first fluid path is disposed adjacent the second end, the first fluid path defining a flow path from the second interior area, the second fluid path configured to allow unidirectional flow from the second interior area through the peripheral wall. A first biasing member is made from a shape-memory alloy disposed in the second interior area adjacent the first end, the shape memory alloy moving between a first position and a second position in response to a change in temperature. A first piston member is movably disposed within the second interior area and coupled to the first biasing member, the first piston member defining a dispensing chamber within the second interior area.

According to another aspect of the invention, a filter is provided. The filter includes a housing defining an inlet fluid opening and an outlet fluid opening, the inlet fluid opening and the outlet fluid opening defining a first fluid path through the filter. A filter element is disposed inside the filter housing, the filter element being disposed in the first flow path such that fluid flows through the filter element. An additive cartridge is arranged for dispersing an additive within a filter housing, the additive cartridge includes an additive cartridge housing having a peripheral wall, the additive cartridge housing defining first interior area and a second interior area divided by a first wall, the second interior area having a first end and a second end. A first fluid path is disposed within the second interior area, the first fluid path defining a flow path from the second interior area through the outer peripheral wall to the first flow path, the first fluid path configured to allow unidirectional flow from the second interior area through the peripheral wall. A first biasing member is made from a shape-memory alloy disposed in the second interior area adjacent the first end, the shape memory allow moving between a first position and a second position in response to a change in temperature. A first piston member is movably disposed within the second interior area and coupled to the biasing member, the first piston member defining a dispensing chamber within the second interior area.

According to yet another aspect of the invention, a method for dispersing an additive from an additive cartridge disposed in a housing of an oil filter is provided. The method includes providing an additive cartridge having a first interior area and a second interior area. A first biasing member is provided in the second interior area, the first biasing member being made from a shape memory alloy. The first biasing member is heated from a first temperature to a second temperature. The first biasing member is moved from a first position to a second position in response to the heating. The additive flows from the second interior area to through a peripheral wall of the additive cartridge as the first biasing member moves from the first position to the second position. The first biasing member is cooled to the first temperature. The first biasing member is moved from the second position to the first position in response to the cooling. The additive flows from the first interior area to the second interior area as the first biasing member moves from the second position to the first position.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of an oil filter constructed in accordance with an exemplary embodiment of the invention;

FIG. 2 is a side sectional view of the oil filter of FIG. 1 in accordance with one embodiment of the invention;

FIG. 3 is a side sectional view of the oil filter of FIG. 1 in accordance with another embodiment of the invention;

FIGS. 4-6 are side schematic views of an additive cartridge for use with the oil filter of FIG. 1; and,

FIG. 7 is a side schematic view of another additive cartridge for use with the oil filter of FIG. 1.

The detailed description explains embodiments of the invention, together with advantages and features, by way of example with reference to the drawings.

### DETAILED DESCRIPTION OF THE INVENTION

Embodiments of the present invention provide advantages in dispersing an additive composition into oil, such as motor oil to increase the service life of the oil. Embodiments described herein provide for an additive dispersion cartridge that injects oil into an oil flow path within an oil filter where the additive compound is injected once per engine heating cycle. The additive cartridge has a temperature driven piston arrangement that disperses a metered amount of additive compound when the engine oil achieves a desired temperature level. The piston arrangement includes a biasing member made from a shape memory alloy that moves between an compressed position and an extended position. The piston arrangement further includes a valve arrangement that allows the additive compound to be flowed from a reservoir when the engine cools and dispersed to the oil upon the heating of the engine to a desired level.

The present application is related to the following patent applications, the contents each of which are incorporated herein by reference thereto: Ser. No. 10/352,344, filed Jan. 27, 2003; Ser. No. 09/867,973, filed May 30, 2001; Ser. No. 09/566,034 filed May 8, 2000; U.S. patent application Ser. No. 10/863,581, filed Jun. 8, 2004; U.S. patent application Ser. No. 11/488,466, filed Jul. 18, 2006; U.S. patent application Ser. No. 11/533,649 filed Sep. 20, 2006; U.S. patent application Ser. No. 11/845,042, filed Aug. 25, 2007; U.S. patent application Ser. No. 11/845,043, filed Aug. 25, 2007; U.S. patent application Ser. No. 11/846,265, filed Aug. 28, 2007; U.S. provisional patent application Ser. No. 60/889,728, filed Feb. 13, 2007; U.S. provisional patent application Ser. No. 60/910,772 filed Apr. 9, 2007; U.S. provisional patent application Ser. No. 60/985,193 filed Nov. 2, 2007, U.S. patent application Ser. No. 12/030,595 filed Feb. 13, 2008, and U.S. patent application Ser. No. 12/032,241 filed Feb. 15, 2008 the contents each of which are incorporated herein by reference thereto.

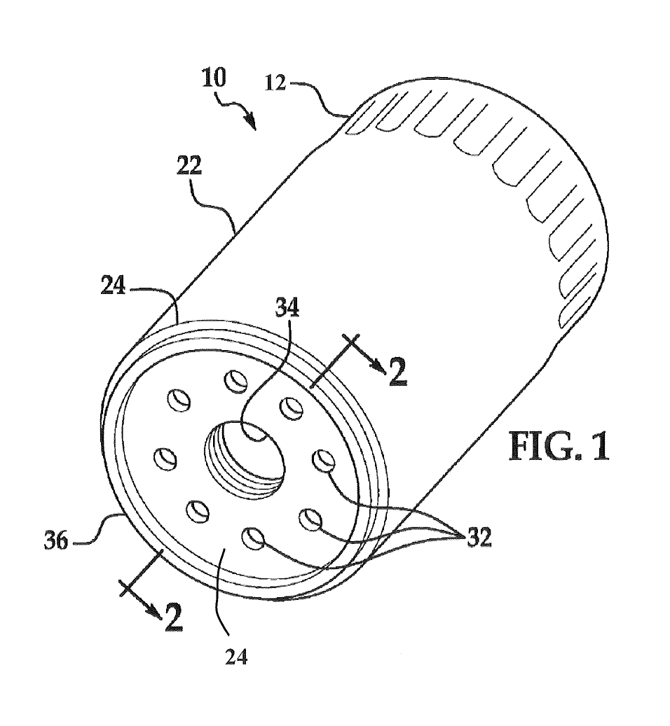

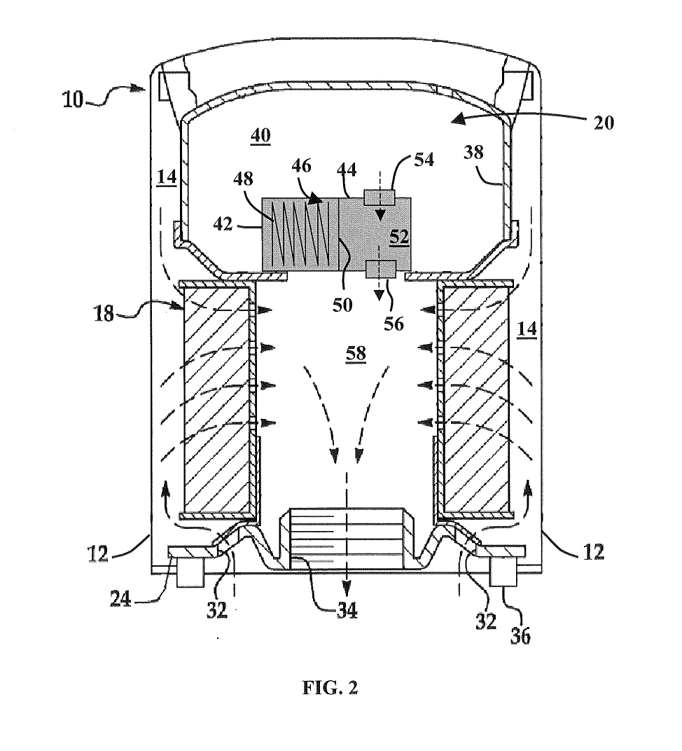

Referring to FIG. 1 and FIG. 2, there is shown an oil filter 10 in accordance with an embodiment of the invention. The oil filter 10 generally includes a hollow cylindrical housing 12 which defines a hollow interior chamber 14. A mechanical filter medium 18 is disposed within that chamber along with an additive cartridge 20 arranged on one end. The housing 12 may also include a tapping pate 24 that is sealingly coupled to the housing 12. In some embodiments, a center tube may optionally be provided within the filter housing to support and reinforce the mechanical filter element 18.

In the exemplary embodiment, the filter element 18 is a conventional cylindrical member made of accordion-pleated filter paper. In other embodiments, the filter element 18 may be manufactured in accordance with the teachings of U.S. patent application Ser. No. 11/533,649 filed Sep. 20, 2006 or U.S. application Ser. No. 11/845,042 filed Aug. 25, 2006, the contents of each being incorporated herein by reference in their entirety.

The tapping plate 24 may include a number of inlet ports 32 arranged in a circular pattern. The tapping plate also includes an outlet port 34. The outlet port has a thread portion that allows the mounting of the filter 10 on hollow tubular fitting on an engine block (not shown). An annular seal or gasket 36 is disposed in a groove formed on the bottom surface of the filter 10 to resist oil leakage outwardly from the filter 10.

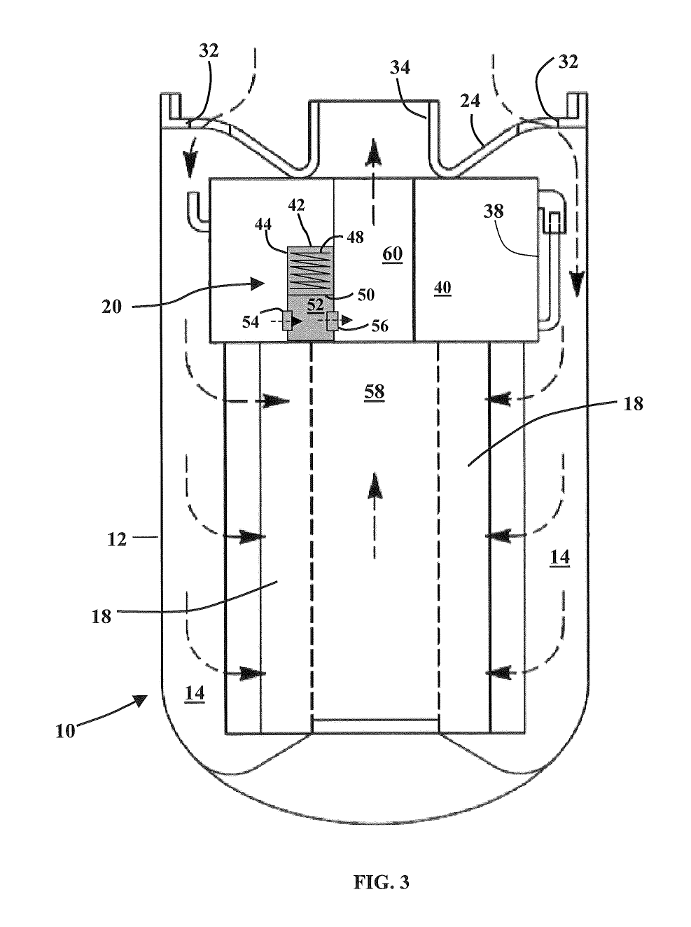

Referring to FIGS. 2-3, the additive dispensing cartridge 20 includes an outer shell 38 forming a peripheral wall that defines an interior area 40 for housing a reservoir. The reservoir is sized to contain a desired amount of an additive dispersant material suitable for the expected operational life of the filter 10. Adjacent the inner area 40 is a metering device 42. The metering device 42 includes a wall 44 that defines another interior area 46, which contains a biasing member 48, a piston member 50 and a dispensing chamber 52. As will be discussed in more detail below, the biasing member 48 is made from a shape memory alloy that allows the biasing member 48 to change shape and move in response to a change in temperature. In the exemplary embodiment, the biasing member 48 may be made from a Cu—Zn—Al—Ni alloy, a Cu—Al—Ni alloy or a Ni—Ti alloy.

An inlet valve 54 forms a flow path from the interior area 40 into the dispensing chamber 52. The inlet valve 54 may be a check valve that only allows the additive to flow in one direction into the dispensing chamber. An outlet valve 56 forms a flow path from the dispensing chamber into a center area 58 within the filter medium 18. The outlet valve 56 is configured to open at a predetermined pressure within the dispensing chamber 52 and only allow flow from the dispensing chamber 52 into the center area 58. The valves 54, 56 may be any suitable check valve, including but not limited to a ball check valve, a diaphragm check valve, a swing check valve, a tilting disk check valve, a stop check valve or a lift check valve, or a combination of the foregoing for example.

In one embodiment, shown in FIG. 2, the additive cartridge 20 is disposed adjacent the closed end of the housing 12. In this embodiment, the additive flows from the additive cartridge 20 into one end of the center area 58 within the filter medium 18. In another embodiment, shown in FIG. 3, the additive cartridge 20 is disposed between the center area 58 and the outlet port 34. In this embodiment, the interior area 40 forms an annularly-shaped reservoir with a cylindrical opening 60 that extends through the shell 38 to allow oil to flow to the outlet port 34. The outlet valve 56 is arranged to flow the additive into the opening 60.

It should be appreciated that while embodiments herein describe the additive cartridge as being internal to the filter 10, this is for exemplary purposes and the claimed invention should not be so limited. In other embodiments, the additive cartridge is external to the filter. Still further, embodiments describe the additive cartridge as being positioned between the filter medium and the outlet port. In other embodiments, the additive cartridge may be positioned in a flow path between the inlet port and the filter medium.

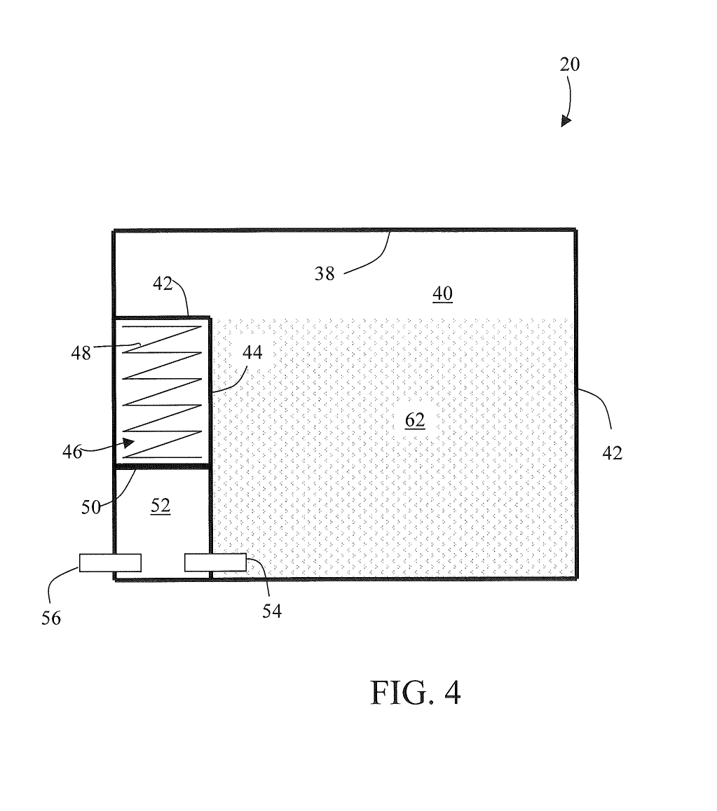

The additive cartridge 20 includes an additive material within the reservoir. The additive 62 (FIG. 4) may be a liquid or semi-liquid form for being released into the oil flow path. The additive 62 may be any one of a detergent or dispersant additive that is configured to suspend particles of soot within the oil, such that in one embodiment, the oil carries the soot particles to the filter for removal from the oil. Alternatively, the dispersant is used to keep the soot in suspension in the oil such that it does not agglomerate and fall out of suspension and thereby accumulate on surfaces and potentially cause wear or plugging issues. Other contemplated beneficial additives are basic conditioners, corrosion inhibitors, metal deactivators, antioxidants, friction modifiers, oil stabilizers, pour point depressants, viscosity index improvers, anti-wear agents, extreme pressure additives, alkaline additives, and combinations of the foregoing.

The additive material 62 may also include a basic salt selected from the group consisting of calcium carbonate, potassium carbonate, potassium bicarbonate, aluminum dihydroxy sodium carbonate, magnesium oxide, magnesium carbonate, zinc oxide, sodium bicarbonate, sodium hydroxide, calcium hydroxide, potassium hydroxide, and mixtures thereof.

Referring now to FIGS. 4-6, the operation of the additive cartridge 20 is described. The interior area 40 is substantially filled with a desired amount of the additive material 62. When initially filled, there is little or no pressure differential across the valve 54 so the additive material 62 will not flow into the dispensing chamber 52. The piston member 50 and biasing member 48 are in an initial position. It should be appreciated that in some embodiments, the dispensing chamber 52 may be initially filled with additive material as well. When the filter 10 is installed on the desired application, such as an internal combustion engine for example, the temperature of the additive compartment will increase as the temperature of the engine increases. In the exemplary embodiment, the additive cartridge 20 will be at a temperature of less than 130° F. in a cold state and greater than 150° F. in a operating or hot state.

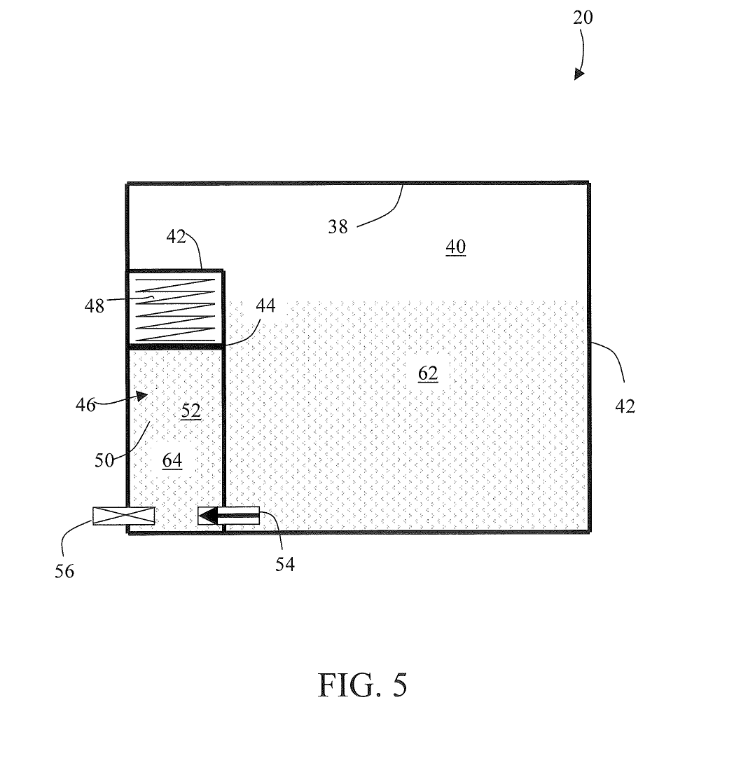

As the temperature of the additive cartridge 20 decreases from an operating temperature (e.g. >150°) to a rest temperature (e.g. <130° F.), the biasing member 48 and the attached piston member 50 move from an initial position (FIG. 4) to a compressed or second position (FIG. 5). This movement of the biasing member 48 increases the size of the dispensing chamber 52 creating a pressure differential across the valve 54. This pressure differential opens the valve 54 allowing additive material 62 to flow along a first flow path through the valve 54 to substantially fill the dispensing chamber with additive material 64 (FIG. 5). The next time the engine (or other desired application) is started, the temperature of the additive cartridge increases.

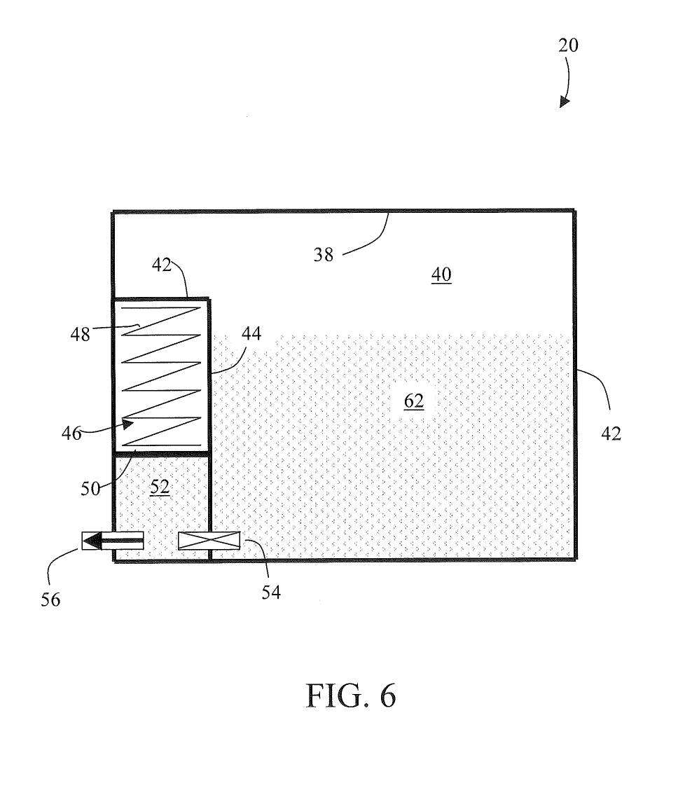

When the operating temperature of the environment causes the cartridge temperature to exceed a predetermined threshold (e.g. 150° F.), the biasing member 48 and the piston member 50 move from the second position back to the third position. This movement decreases the size of the dispensing chamber 52 causing the pressure to increase within the dispensing chamber (FIG. 6). When the pressure exceeds a predetermined threshold, the valve 56 opens allowing the additive material 64 to flow along a second flow path via the valve 56 where it exits the shell 52 and the additive cartridge 20. Thus, for each heating cycle of the engine, one metered amount of additive material will be added to the engine oil.

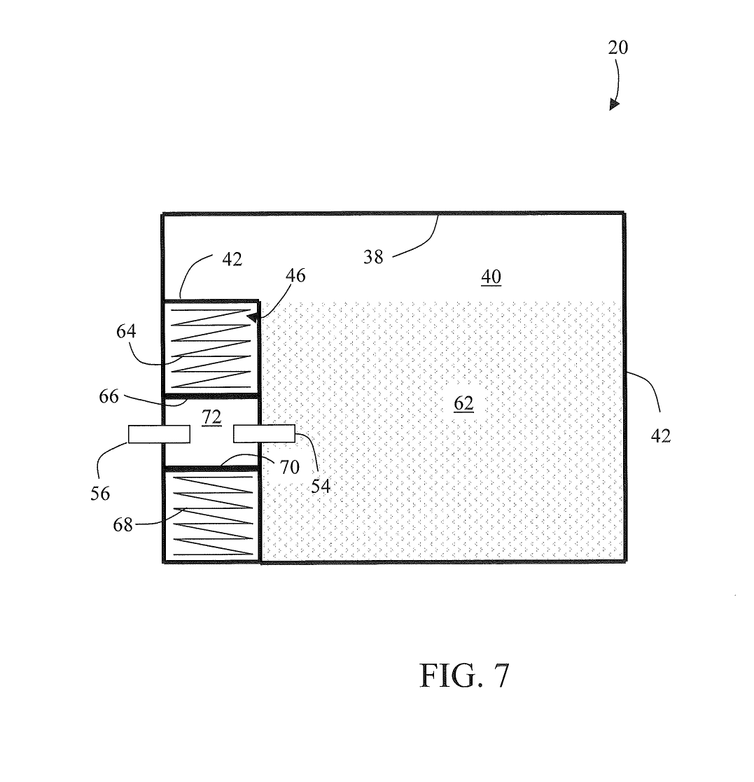

Referring now to FIG. 7, an embodiment is shown of another additive cartridge 20. In this embodiment, the metering device 42 includes a first biasing member 64 coupled to a first piston member 66 arranged within the interior area 46. Also disposed within the interior area 46 is a second biasing member 68 and a second piston member 70. The biasing members 64, 68 are made from a shape memory material, such as but not limited to a Cu—Zn—Al—Ni alloy, a Cu—Al—Ni alloy and a Ni—Ti alloy for example. The piston members 66, 70 are disposed in an opposing arrangement within the interior area 46. A dispensing chamber 72 is defined between the piston members 66, 70. The valves 54, 56 provide a flow path into and out of the dispensing chamber respectively.

The embodiment of FIG. 7 operates substantially similar to that described above. The biasing members are responsive to changes in temperature to move piston members 66, 70 between a first position and a second position when temperature thresholds are reached. When the additive cartridge 20 is cooled below a lower temperature threshold (e.g. <130° F.), the biasing members 64, 68 contract causing the additive material 62 to flow into and substantially fill the dispensing chamber 72. When the temperature of the additive cartridge 20 is increased above an upper temperature threshold, the biasing members 64, 68 expand moving the piston members 66, 70 toward each other and causing an increase in the pressure within the dispensing chamber 72. Once the pressure increases beyond a threshold, the valve 56 opens allowing the additive material to flow out of the additive cartridge 20.

In other embodiments, it is contemplated that the metering device 42 may be constructed with two biasing members acting on a single piston member. In one embodiment, a second biasing member may be disposed within the dispensing chamber. The second biasing member could be made from a shape memory that expands when cooled (pushing on the piston member) and contracts when heated. Thus the two biasing members would cooperate to act upon the single piston member to draw and disperse the additive material. In yet another embodiment, a second biasing member could be co-wound together.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An additive cartridge for dispersing an additive within a filter housing, the additive cartridge comprising:
an additive cartridge housing having a peripheral wall, the additive cartridge housing defining a first interior area and a second interior area being divided by a first wall, the first interior area defining a receiving area for receipt of the additive therein, the second interior area having a first end and a second end;
a first fluid path disposed adjacent the second end, the first fluid path defining a flow path from the second interior area, the first fluid path configured to allow unidirectional flow from the second interior area through the peripheral wall;
a first biasing member made from a shape memory alloy disposed in the second interior area adjacent the first end, the shape memory alloy moving between a first position and a second position in response to a change in temperature; and,
a first piston member movably disposed within the second interior area and coupled to the first biasing member, the first piston member defining a dispensing chamber within the second interior area.

2. The additive cartridge of claim 1 further comprising a second fluid path between the first interior area and the second interior area, the first fluid path configured to allow unidirectional flow of the additive from the first interior to the second interior area.

3. The additive cartridge of claim 1 wherein the first biasing member is in the first position at a first temperature and in the second position at a second temperature.

4. The additive cartridge of claim 3 wherein the first temperature is a temperature equal to or less than 130 F and the second temperature is a temperature equal to or greater than 150 F.

5. The additive cartridge of claim 3 wherein the shape memory alloy is selected from a group comprising: a Cu—Zn—Al—Ni alloy, a Cu—Al—Ni alloy and a Ni—Ti alloy.

6. The additive cartridge of claim 1 further comprising:
a second biasing member made from a shape-memory alloy disposed in the second interior area between the first fluid path and the second end, the shape memory alloy moving between a third position and a fourth position in response to a change in temperature; and,
a second piston member movably disposed within the second interior area and coupled to the second biasing member.

7. A filter comprising:
a filter housing defining an inlet fluid opening and an outlet fluid opening, the inlet fluid opening and the outlet fluid opening defining a first fluid path through the filter;
a filter element disposed inside the filter housing, the filter element being disposed in the first fluid path such that fluid flows through the filter element; and
an additive cartridge for dispersing an additive within the filter housing, the additive cartridge comprising:
an additive cartridge housing having an outer peripheral wall, the additive cartridge housing defining a first interior area and a second interior area divided by a first wall, the second interior area having a first end and a second end;
a second fluid path disposed within the second interior area, the second fluid path defining a flow path from the second interior area through the outer peripheral wall to the first fluid path, the second fluid path configured to allow unidirectional flow from the second interior area through the outer peripheral wall;
a first biasing member made from a shape memory alloy disposed in the second interior area adjacent the first end, the shape memory alloy moving between a first position and a second position in response to a change in temperature; and,
a first piston member movably disposed within the second interior area and coupled to the first biasing member, the first piston member defining a dispensing chamber within the second interior area.

8. The filter of claim 7 wherein the second fluid path is fluidly coupled to the first fluid path between the filter element and the outlet fluid opening.

9. The filter of claim 8 wherein the first biasing member is in the first position at a first temperature and in the second position at a second temperature.

10. The additive cartridge of claim 9 wherein the first temperature is a temperature equal to or less than 130 F and the second temperature is a temperature equal to or greater than 150 F.

11. The additive cartridge of claim 10 further comprising a third fluid path between the first interior area and the second interior area, the third fluid path configured to allow unidirectional flow from the first interior area to the second interior area.

12. The additive cartridge of claim 11 further comprising:
a first check valve disposed in the second fluid path, the first check valve being configured to allow uni-directional flow of additive from the dispensing chamber to the first fluid path; and,
a second check valve disposed in the third fluid path, the second check valve being configured to allow uni-directional flow of additive from the first interior area to the dispensing chamber.

13. The additive cartridge of claim 7 further comprising:
a second biasing member made from a shape-memory alloy disposed in the second interior area adjacent the second end, the shape memory alloy moving between a third position and a fourth position in response to a change in temperature; and,
a second piston member movably disposed within the second interior area and coupled to the second biasing member.

14. A method for dispersing an additive from an oil filter, the method comprising:
providing an additive cartridge having a first interior area and a second interior area;
providing a first biasing member in the second interior area, the first biasing member being made from a shape memory alloy;
heating the first biasing member from a first temperature to a second temperature;
moving the first biasing member from a first position to a second position in response to the heating;
flowing additive from the second interior area to through a peripheral wall of the additive cartridge as the first biasing member moves from the first position to the second position;
cooling the first biasing member to the first temperature;
moving the first biasing member from the second position to the first position in response to the cooling;
flowing the additive from the first interior area to the second interior area as the first biasing member moves from the second position to the first position.

15. The method of claim 14 further comprising preventing flow of additive from the second interior area to the first interior area when flowing the additive from the second interior area through the peripheral wall.

16. The method of claim 15 further comprising preventing fluid flow through the peripheral wall to the second interior area when flowing the additive from the first interior area to the second interior area.

17. The method of claim 16 further comprising:
providing a second biasing member in the second interior area, the second biasing member made from a shape memory alloy;
heating the second biasing member;
moving the second biasing member from a third position to a fourth position in response to the hearing of the second biasing member; and,
flowing additive from the second interior area through the peripheral wall as the second biasing member moves from the third position to the fourth position;

18. The method of claim 17 further comprising:
cooling the second biasing member;
moving the second biasing member from the fourth position to the third position; and,
flowing additive from the first interior area to the second interior area as the second biasing member moves from the fourth position to the third position.

19. The method of claim 18 wherein the additive composition comprises at least one additive selected from a group consisting of basic conditioners, corrosion inhibitors, metal deactivators, antioxidants, dispersants, friction modifiers, oil stabilizers, pour point depressants, detergents, viscosity index improvers, anti-wear agents, extreme pressure additives, and mixtures thereof and the additive composition is a liquid.

20. The method of claim 18 wherein the additive composition comprises a basic salt selected from a group consisting of calcium carbonate, potassium carbonate, potassium bicarbonate, aluminum dihydroxy sodium carbonate, magnesium oxide, magnesium carbonate, zinc oxide, sodium bicarbonate, sodium hydroxide, calcium hydroxide, potassium hydroxide, and mixtures thereof and the additive composition is a liquid.
